(19) United States
(12) Patent Application Publication
(10) Pub. No.: US 2017/0171473 A1
(43) Pub. Date: Jun. 15, 2017

(54) METHOD FOR REALIZING PHOTOGRAPHING EFFECT OF A DISTORTING MIRROR AND ELECTRONIC DEVICE

(71) Applicants: LE HOLDINGS (BEIJING) CO., LTD., Beijing (CN); Lemobile Information Technology (Beijing) Co., Ltd., Beijing (CN)

(72) Inventor: Haining HUANG, Beijing (CN)

(21) Appl. No.: 15/245,116

(22) Filed: Aug. 23, 2016

Related U.S. Application Data
(63) Continuation of application No. PCT/CN2016/088886, filed on Jul. 6, 2016.

(30) Foreign Application Priority Data
Dec. 15, 2015 (CN) 201510938775.8

(51) Int. Cl. H04N 5/262; G06T 7/00; G06T 3/00

(52) U.S. Cl. CPC H04N 5/2621; H04N 5/2628; G06T 3/0093; G06T 7/0081; H04N 5/23293

(57) ABSTRACT

An embodiment of the present disclosure discloses a method for realizing a photographing effect of a distorting mirror and an electronic device. The method includes the following steps: operating a photographing mode of the electronic device; acquiring image data of each frame which is captured in real time by a camera module of the electronic device, processing each frame image data in real time according to a preset distorting-mirror algorithm, and displaying the processed image data on a photograph preview interface of the electronic device; receiving a photographing instruction, and acquiring the image data that is collected by the camera module, processing the collected image data according to the preset distorting-mirror algorithm, and generating a compressed and encoded picture according to the processed image data.

### CROSS-REFERENCE TO RELATED APPLICATIONS

This application is a continuation of International Application No. PCT/CN2016/088886 filed on Jul. 6, 2016, which is based upon and claims priority to Chinese Patent Application No. 201510938775.8, filed on Dec. 15, 2015, the entire contents of which are incorporated herein by reference.

### FIELD OF TECHNOLOGY

The present disclosure generally relates to the technical field of electronic device, in particular to a method for realizing a photographing effect of a distorting mirror and an electronic device.

### BACKGROUND

A distorting mirror is very popular due to its interestingness, but a specific distorting-mirror effect cannot be conveniently saved as an electronic photo for commemoration or sharing.

Nowadays, photographing technology of smartphones is quite mature, but there has been no mature solution to add the distorting-mirror effect into a camera application at present. If a user wants to add the distorting-mirror effect to a photo, only post-processing software such as PhotoShop (a kind of image processing software) and the like is available for processing.

### SUMMARY

An embodiment of the present disclosure discloses a method for realizing a photographing effect of a distorting mirror and an electronic device to solve the problems that there has been no mature solution to add the distorting-mirror effect into a camera application of a mobile phone at present and post-processing software for processing to realize the distorting-mirror effect has the disadvantages of quite low efficiency, poor user experience and a certain loss of photo quality to a certain extent.

To solve the problem above, an embodiment of the present disclosure discloses a method for realizing a photographing effect of a distorting mirror, including: operating a photographing mode of an electronic device; acquiring each frame image data that is captured by a camera module of the electronic device in real time, processing the each frame image data in real time according to a preset distorting-mirror algorithm, and displaying the processed image data on a photograph preview interface of the electronic device; receiving a photographing instruction; and acquiring the image data that is collected by the camera module, processing the collected image data according to the preset distorting-mirror algorithm, and generating a compressed and encoded picture according to the processed image data.

To solve the problem above, an embodiment of the present disclosure discloses an electronic device, including: at least one processor and a memory communicably connected with the at least one processor for storing instructions executable by the at least one processor, wherein execution of the instructions by the at least one processor causes the at least one processor to: operate a photographing mode of the electronic device; acquire image data of each frame that is captured in real time by a camera module of the electronic equipment, process the each frame image data in real time according to a preset distorting-mirror algorithm, and display the processed image data on a photograph preview interface of the electronic device; receive a photographing instruction: and acquire the image data that is collected by the camera module, process the collected image data according to the preset distorting-mirror algorithm, and generate a compressed and encoded picture according to the processed image data.

To solve the problem above, the embodiment of the present disclosure further discloses a non-transitory computer readable medium storing executable instructions that, when executed by an electronic device, cause the electronic device to: operate a photographing mode of an electronic device: acquire image data of each frame captured in real time by a camera module of the electronic device, process the each frame image data in real time according to a preset distorting-mirror algorithm, and display the processed image data on a photograph preview interface of the electronic device; receive a photographing instruction; and acquire the image data that is collected by the camera module, process the collected image data according to the preset distorting-mirror algorithm, and generate a compressed and encoded picture according to the processed image data.

According to an aspect of the present disclosure, there is provided a computer program, including a computer readable code, wherein the computer readable code causes an electronic device to execute the method for realizing the photographing effect of the distorting mirror for the electronic equipment above when operated on the electronic device.

According to the method for realizing the photographing effect of the distorting mirror and the electronic device disclosed by the embodiment of the present disclosure, after a photographing mode of the electronic device is operated, each frame image data that is captured by a camera module of the electronic device in real time is acquired, and the each frame image data is processed in real time according to a preset distorting-mirror algorithm, and the processed image data is displayed on a photograph preview interface of the electronic device; after a photographing instruction is received, the image data that is collected by the camera module is acquired, and is processed according to the preset distorting-mirror algorithm, and a compressed and encoded picture is generated according to the processed image data. Therefore, the introduction of the distorting-mirror effect into photographing based on the camera function of the electronic device directly is realized, so that the photograph preview interface and a finished photo can directly present the distorting-mirror effect when a user takes a picture, which is intuitional and high-efficiency; in addition, as the frame image data that is collected by the camera module can be processed directly according to the preset distorting-mirror algorithm before the compression and encoding, pixels of the picture can be prevented from loss to the maximum extent, and therefore user experience is increased.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a step flow chart of a method for realizing a photographing effect of a distorting mirror according to an embodiment of the present disclosure.

FIG. 2 is a schematic diagram of image data in a first designated image region of a method for realizing a photographing effect of a distorting mirror according to an embodiment of the present disclosure.

FIG. 3 is a schematic diagram of compression processed image data in a first designated image region of a method for realizing a photographing effect of a distorting mirror according to an embodiment of the present disclosure.

FIG. 4 is a schematic diagram of expansion processed image data in a first designated image region of a method for realizing a photographing effect of a distorting mirror according to an embodiment of the present disclosure.

FIG. 5 is a schematic diagram of a color bar in a third designated image region of a method for realizing a photographing effect of a distorting mirror according to an embodiment of the present disclosure.

FIG. 6 is a schematic diagram of a color bar that is deformed by forward compression of a method for realizing a photographing effect of a distorting mirror according to an embodiment of the present disclosure.

FIG. 7 is a schematic diagram of a first image region and a second image region before processing of a method for realizing a photographing effect of a distorting mirror according to an embodiment of the present disclosure.

FIG. 8 is a schematic diagram of a first image region and a second image region that is subjected to linear transition processing of a method for realizing a photographing effect of a distorting mirror according to an embodiment of the present disclosure.

FIG. 9 is a schematic diagram of a first image region and a second image region that is subjected to quadratic function transition processing of a method for realizing a photographing effect of a distorting mirror according to an embodiment of the present disclosure.

FIG. 10 is a schematic diagram of a first image region and a second image region that is subjected to circular arc transition processing of a method for realizing a photographing effect of a distorting mirror according to an embodiment of the present disclosure.

FIG. 11 is a structural block diagram of a device for realizing a photographing effect of a distorting mirror according to an embodiment of the present disclosure.

FIG. 12 is a schematic diagram of a process of processing image data of a device for realizing a photographing effect of a distorting mirror according to an embodiment of the present disclosure.

FIG. 13 schematically illustrates a block diagram of an electronic device used to execute the method according to the present disclosure.

FIG. 14 schematically illustrates a memory cell used to keep or carry a program code for realizing the method according to the present disclosure.

### DESCRIPTION OF THE EMBODIMENTS

In order to clarify the objects, technical solutions and advantages of the embodiments of the present disclosure, the technical solutions in the embodiments of the present disclosure will be described in a clear and fully understandable way in connection with the drawings related to the embodiments of the present disclosure. It is obvious that the described embodiments are just a part but not all of the embodiments of the present disclosure. Based on the described embodiments herein, a person skilled in the art can obtain other embodiment(s), without any creative work, which should be within the scope of the present disclosure.

According to the embodiment of the present disclosure, the electronic device may be electronic device having a photographing function such as a mobile phone, a camera, a notebook computer or a tablet computer and the like.

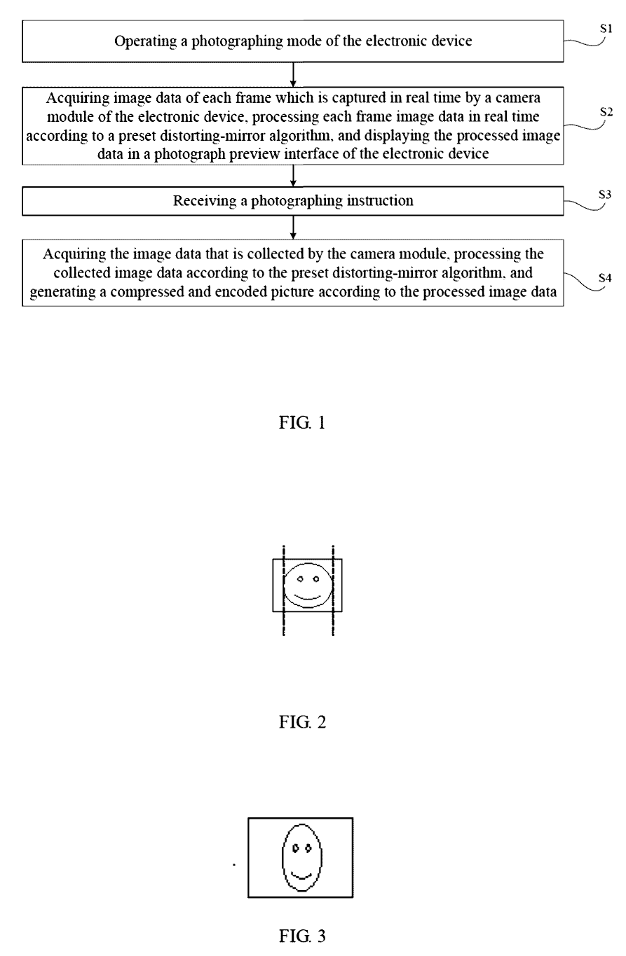

With reference to FIG. 1, which illustrates a step flow chart of a method for realizing a photographing effect of a distorting mirror according to an embodiment of the present disclosure, the method for realizing the photographing effect of the distorting mirror may include the following steps.

Step S1, operating a photographing mode of the electronic device; wherein the step S1 of operating the photographing mode of the electronic device is initiated when a user opens a camera function of the electronic device.

Step S2, acquiring image data of each frame which is captured in real time by a camera module of the electronic device, processing each frame image data in real time according to a preset distorting-mirror algorithm, and displaying the processed image data on a photograph preview interface of the electronic device;

wherein, the camera module may include a camera, an analog-to-digital conversion module and the like. Specifically, after step S1, the camera module of the electronic device finds a view in real time; namely, the camera module receives optical information and performs earlier stage processing such as analog-to-digital conversion and the like on the received optical information to obtain the each frame image data.

According to step S2, when the camera module finds a view, each frame image data of a found view can be directly processed according to the preset distorting-mirror algorithm in advance and then transmitted to a display screen of the electronic device for display by means of a software system of the electronic device, so as to ensure no loss of pixels of a picture on a photograph preview interface, such as the photograph preview interface of a camera APP (Application), to the maximum extent, and therefore a user can intuitively see the distorting-mirror effect of a photo in real time on the photograph preview interface.

Step S3, receiving a photographing instruction;

specifically, when the user confirms that the current distorting-mirror effect is a required distorting-mirror effect according to the photograph preview interface, the step S3 of receiving the photographing instruction is initiated if the user pushes a photographing button.

Step S4, acquiring the image data that is collected by the camera module, processing the collected image data according to the preset distorting-mirror algorithm, and generating a compressed and encoded picture according to the processed image data.

After step S3, the camera module collects optical information and performs earlier stage processing such as analog-to-digital conversion and the like on the collected optical information to obtain the collected image data.

Wherein, in one embodiment of the present disclosure, the collected image data can be cached to a system memory after the camera module collects the image data, so that the collected image data can be efficiently processed according to the preset distorting-mirror algorithm according to step S4.

Wherein, according to step S4, the image data that is collected by the camera module and has not been compressed and encoded is processed directly according to the preset distorting-mirror algorithm by means of the software system of the electronic device; furthermore, the processed image data is compressed and encoded to a picture in a preset format by means of the software system of the electronic device, and the picture has the distorting-mirror effect required by the user. Therefore, no loss of pixels of a finished picture can be ensured to the maximum extent, and the user experience is increased greatly. Specifically, the preset format may be a JPEG (Joint Photographic Experts Group) format, a GIF (Graphics Interchange Format), a PNG (Portable Network Graphic Format) and like format.

Wherein, after the collected image data is cached to the system memory and the compressed and encoded picture is generated according to the processed image data in step S4, the system memory that is occupied by the collected by the image data can also be released, so that system efficiency can be increased.

Specifically, according to an embodiment of the present disclosure, the preset distorting-mirror algorithm may include the step of compressing the image data in the first designated image region according to a first preset proportion.

Wherein, the step of compressing the image data in the first designated image region according to the first preset proportion may be the step of compressing the number of pixels of the image data in the first designated image region according to the first preset proportion, wherein the first preset proportion is greater than 0 and smaller than 1.

Specifically, after the user opens the camera function, a compression direction selection list may be displayed in the photograph preview interface, wherein the compression direction selection list may include a transverse compression button, a longitudinal compression button, a circular compression button and the like; a compression proportion regulation button or a compression proportion selection list and the like may be displayed in the photograph preview interface.

Wherein, when the user selects the transverse compression button, two longitudinal regulation lines are displayed in the photograph preview interface, the region between the two longitudinal regulation lines is the first designated image region, and the dimension of the first designated image region can be regulated when the user moves any of the longitudinal regulation lines; when the user selects the longitudinal compression button, two transverse regulation lines are displayed in the photograph preview interface, the region between the two transverse regulation lines is the first designated image region, and the dimension of the first designated image region can be regulated when the user moves any of the transverse regulation lines; when the user selects the circular compression button, a circular regulation line is displayed in the photograph preview interface, the region surrounded by the circular regulation line is the first designated image region, the dimension of the first designated image region can be regulated when the user regulates the radius of the circle. In addition, the user may regulate the first preset proportion by means of the compression proportion regulation button or the compression proportion selection list and the like.

According to an embodiment of the present disclosure, when the user selects the transverse compression button and sets the first preset proportion as 50%, and the image data in the first designated image region is as shown in FIG. 2, the image data that is in the first designated image region and is compressed according to the preset distorting-mirror algorithm is as shown in FIG. 3, wherein the two longitudinal regulation lines are as shown in dotted lines in FIG. 2.

Specifically, according to an embodiment of the present disclosure, the preset distorting-mirror algorithm may include the step of expanding the image data in a second designated image region according to a second preset proportion, wherein the second preset proportion is larger than 1.

Wherein, the step of expanding the image data in the second designated image region according to the second preset proportion may be the step of expanding the number of pixels of the image data in the second designated image region according to the second preset proportion.

Specifically, after the user opens the camera function, an expansion direction selection list may be displayed in the photograph preview interface, wherein the expansion direction selection list may include a transverse expansion button, a longitudinal expansion button, a circular expansion button and the like; an expansion proportion regulation button or an expansion proportion selection list and the like may be displayed in the photograph preview interface.

Wherein when the user selects the transverse expansion button, two longitudinal regulation lines are displayed in the photograph preview interface, the region between the two longitudinal regulation lines is the second designated image region, and the dimension of the second designated image region can be regulated when the user moves any of the longitudinal regulation lines; when the user selects the longitudinal expansion button, two transverse regulation lines are displayed in the photograph preview interface, the region between the two transverse regulation lines is the second designated image region, and the dimension of the second designated image region can be regulated when the user moves any of the transverse regulation lines; when the user selects the circular compression button, a circular regulation line is displayed in the photograph preview interface, the region surrounded by the circular regulation line is the second designated image region, the dimension of the second designated image region can be regulated when the user regulates the radius of the circle. In addition, the user may regulate the second preset proportion by means of the expansion proportion regulation button or the expansion proportion selection list and the like.

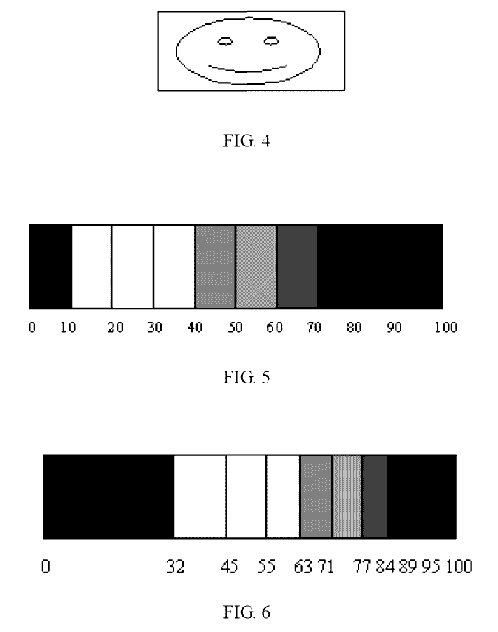

According to an embodiment of the present disclosure, when the user selects the transverse compression button and sets the second preset proportion as 200%, and the image data in the second designated image region is identical to that in the first designated image region, namely the image data in the second designated image region is as shown in FIG. 2, the image data that is in the first designated image region and is expanded according to the preset distorting-mirror algorithm is as shown in FIG. 4.

According to a further embodiment of the present disclosure, the preset distorting-mirror algorithm may include the steps of equally dividing pixels in a third designated image region into 100 portions along a preset direction and giving different coordinates in order, wherein each portion of pixels corresponds to a coordinate ranging from 1 to 100, the coordinates corresponding to each portion of pixels are transformed according to a preset transformation formula, and finally the each portion of pixels is shifted to the transformed coordinates, wherein the preset direction may be a transverse direction, a longitudinal direction or a circumferential direction and the like.

Specifically, the preset transformation formula specifically may be:

y=10*\sqrt{x}, or

y=(x/10)²

wherein x is a coordinate corresponding to any of the 100 portions of pixels, and y is a transformed coordinate.

It should be noted that: as for the preset transformation formula y=10*\sqrt{x} or y=(x/10)², when the value of x ranges from 0 to 100, the value of y also ranges from 0 to 100, wherein the value of x may be an integer or a non-integer within 0-100. Therefore, an image in the third designated image region may be deformed according to the preset distorting-mirror algorithm, pixels of the image in the third designated image region do not overflow or decrease, so that images outside the third designated image region will not be affected.

For example, according to an embodiment of the present disclosure, the image data in the third designated image region is a color bar of uniform lengths as shown in FIG. 5, wherein the color bar has 10 colors in total. According to the preset distorting-mirror algorithm, pixels in the third designated image region are equally divided into 100 groups along a transverse direction, and are given coordinates of 0-100 in turn from left to right. According to the preset distorting-mirror algorithm, coordinates corresponding to each portion of pixels are transformed based on y=10*\sqrt{x} to realize forward compression deformation, then:

a portion of pixels that originally corresponds to a coordinate 0 corresponds to the coordinate 0 after transformation;

a portion of pixels that originally corresponds to a coordinate 10 corresponds to the coordinate 32 after transformation;

a portion of pixels that originally corresponds to a coordinate 20 corresponds to the coordinate 45 after transformation;

a portion of pixels that originally corresponds to a coordinate 30 corresponds to the coordinate 55 after transformation;

a portion of pixels that originally corresponds to a coordinate 40 corresponds to the coordinate 63 after transformation;

a portion of pixels that originally corresponds to a coordinate 50 corresponds to the coordinate 71 after transformation;

a portion of pixels that originally corresponds to a coordinate 60 corresponds to the coordinate 77 after transformation;

a portion of pixels that originally corresponds to a coordinate 70 corresponds to the coordinate 84 after transformation;

a portion of pixels that originally corresponds to a coordinate 80 corresponds to the coordinate 89 after transformation;

a portion of pixels that originally corresponds to a coordinate 90 corresponds to the coordinate 95 after transformation;

a portion of pixels that originally corresponds to a coordinate 100 corresponds to the coordinate 100 after transformation;

therefore, if the color bar in the third designated image region is processed according to the preset distorting-mirror algorithm, the processed color bar is as shown in FIG. 6.

According to another embodiment of the present disclosure, the preset distorting-mirror algorithm may include the following steps: dividing a fourth designated image region into a first image region and a second image region, expanding the image data in the first image region according to a third preset proportion, and compressing the image data in the second image region according to a fourth preset proportion, wherein the third preset proportion is larger than 0 and smaller than 1, and the fourth preset proportion is larger than 1.

Specifically, after the user opens the camera function, a deformation direction selection list may be displayed in the photograph preview interface, wherein the deformation direction selection list may include a left-to-right deformation button, a right-to-left deformation button, a top-to-bottom deformation button, a bottom-to-top deformation button and the like; a rectangular regulation line, a square regulation line, a circular regulation line or the like may be displayed in the photograph preview interface. The region surrounded by the rectangular regulation line, the square regulation line or the circular regulation line is the fourth designated image region, a compression proportion regulation button or a compression proportion selection list and the like may be displayed in the photograph preview interface, or an expansion proportion regulation button or an expansion proportion selection list and the like may be displayed in the photograph preview interface.

Wherein, when the user selects the left-to-right deformation button or the right-to-left deformation button, the fourth designated image region may be divided into a first image region at the left part and a second image region at the right part by a longitudinal dividing line according to the preset distorting-mirror algorithm, the longitudinal dividing line and an outer frame at the upper part of the fourth designated image region has a first intersection, the longitudinal dividing line and an outer frame at the lower part of the fourth designated image region has a second intersection: when the user selects the top-to-bottom deformation button or the bottom-to-top deformation button, the fourth designated image region may be divided into a first image region at the upper part and a second image region at the lower part by a transverse dividing line according to the preset distorting-mirror algorithm, the transverse dividing line and an outer frame at the left part of the fourth designated image region has a third intersection, and the transverse diving line and an outer frame at the right part of the fourth designated image region has a fourth intersection.

Specifically, the dimension of the fourth designated image region may be regulated when the user regulates the rectangular regulation line, the square regulation line or the circular regulation line; the third preset proportion may be regulated by setting a compression proportion regulation button or a compression proportion selection list and the like; the fourth preset proportion may be regulated by setting an expansion proportion regulation button or an expansion proportion selection list.

Wherein, the steps of expanding the image data in the first image region according to the third preset proportion and compressing the image data in the second image region according to the fourth preset proportion include the following steps:

expanding the image data in the first image region in a gradually increased manner according to a preset transition mode, and compressing the image data in the second image region in a gradually increased manner according to a preset transition mode.

It should be noted that: to expand the image data in the first image region in the gradually increased manner according to the preset transition mode and to compress the image data in the second image region in the gradually increased manner according to the preset transition mode can ensure a smooth and gradual transition of images at the edge of the fourth designated image region and images outside the fourth designated image region.

Specifically, after the user opens the camera function, a transition mode selection list may be displayed in the photograph preview interface, wherein the transition mode selection list may include a linear transition button, a quadratic function transition button or a circular arc transition button and the like, wherein a first transition straight line and a second transition straight line are displayed in the photograph preview interface when the user selects the linear transition button, a first transition are line and a second transition arc line are displayed in the photograph preview interface when the user selects the quadratic function transition button, and a transition circular arc is displayed in the photograph preview interface when the user selects the circular arc transition button.

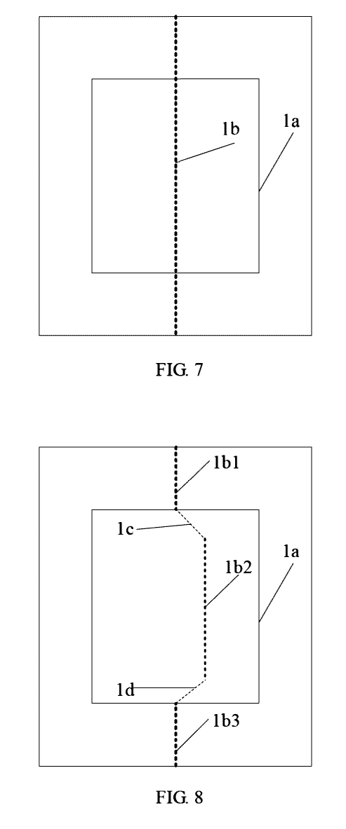

According to an embodiment of the present disclosure, when the user selects the linear transition button and the left-to-right deformation button, the rectangular regulation line 1a and the dividing line 1b that are displayed in the photograph preview interface are as shown in FIG. 7. At this moment, according to the preset distorting-mirror algorithm, the image data at the upper part of the first image region is expanded from top to bottom along the first transition straight line in a gradually increased manner; the image data at the lower part of the first image region is expanded from bottom to top along the second transition straight line in a gradually increased manner: the image data at the upper part of the second image region is compressed from top to bottom along the first transition straight line in a gradually increased manner, the image data at the lower part of the second image region is compressed from bottom to top along the second transition straight line in a gradually increased manner: and the image that is in the fourth designated image region and is processed according to the preset distorting-mirror algorithm is as shown in FIG. 8, wherein the first transition straight line passes through the first intersection, the second transition straight line passes through the second intersection, the first transition straight line is the dotted line 1c as shown in FIG. 8, the second transition straight line is the dotted line 1d as shown in FIG. 8, and the dividing line 1b is cut into 1b1, 1b2 and 1b3 by the dotted line 1c and the dotted line 1d. It should be noted that according to an embodiment of the present disclosure, the user can freely regulate the position of an endpoint of the first transition straight line 1c that is not intersected with the rectangular regulation line 1a as well as the position of an endpoint of the second transition straight line 1d that is not intersected with the rectangular regulation line 1a, so as to a transitionally processed effect of a regulation straight line.

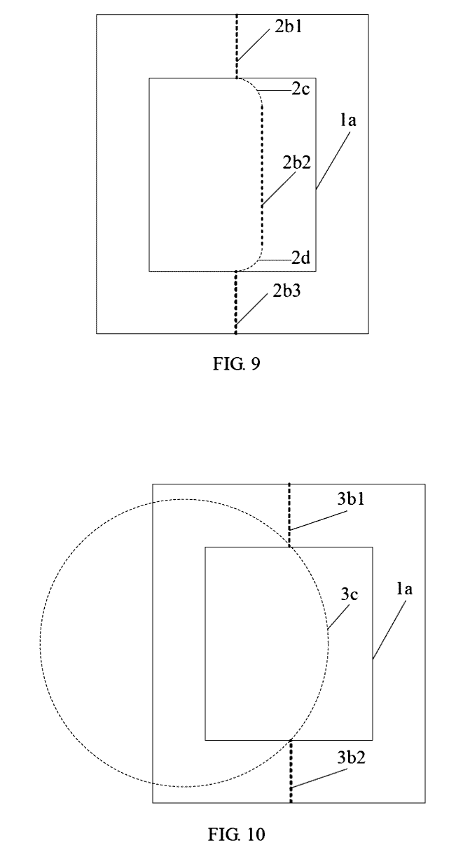

According to another embodiment of the present disclosure, when the user selects the quadratic function transition button and the left-to-right deformation button, the rectangular regulation line 1a and the dividing line 1b that are displayed in the photograph preview interface are as shown in FIG. 7. At this moment, according to the preset distorting-mirror algorithm, the image data at the upper part of the first image region is expanded from top to bottom along the first transition arc line in a gradually increased manner, the image data at the lower part of the first image region is expanded from bottom to top along the second transition are line in a gradually increased manner; the image data at the upper part of the second image region is compressed from top to bottom along the first transition arc line in a gradually increased manner, the image data at the lower part of the second image region is compressed from bottom to top along the second transition arc line in a gradually increased manner; and the image that is in the fourth designated image region and is processed according to the preset distorting-mirror algorithm is as shown in FIG. 9, wherein the first transition arc line passes through the first intersection, the second transition arc line passes through the second intersection, the first transition arc line is the dotted line 2c as shown in FIG. 9, the second transition are line is the dotted line 2d as shown in FIG. 9, and the dividing line 1b is cut into 2b1, 2b2 and 2b3 by the dotted line 2c and the dotted line 2d. It should be noted that: according to an embodiment of the present disclosure, the user can freely regulate the position of an endpoint of the first transition arc line 2c that is not intersected with the rectangular regulation line 1a as well as the position of an endpoint of the second transition arc line 2d that is not intersected with the rectangular regulation line 1a, so as to realize a transitionally processed effect of a regulation quadratic function.

According to a further embodiment of the present disclosure, when the user selects the circular arc transition button and the left-to-right deformation button, the rectangular regulation line 1a and the dividing line 1b that are displayed in the photograph preview interface are as shown in FIG. 7. At this moment, according to the preset distorting-mirror algorithm, the image data at the upper part of the first image region is expanded from top to bottom along a transition circular are in a gradually increased manner; the image data at the lower part of the first image region is expanded from bottom to top along the transition circular arc in a gradually increased manner; the image data at the upper part of the second image region is compressed from top to bottom along the transition circular arc in a gradually increased manner; the image data at the lower part of the second image region is compressed from bottom to top along the transition circular arc in a gradually increased manner, and the image that is in the fourth designated image region and is processed according to the preset distorting-mirror algorithm is as shown in FIG. 10, wherein the transition circular arc passes through the first intersection and the second intersection, the transition circular arc is the dotted line 3c as shown in FIG. 10, and the dividing line 1b is cut into 3b1 and 3b2 by the dotted line 3c.

It should be noted that: when the user selects the right-to-left deformation button as well as the linear transition button, the quadratic function transition button or the circular arc transition button, or when the user selects the top-to-bottom deformation button as well as the linear transition button, the quadratic function transition button or the circular are transition button, or when the user selects the bottom-to-top deformation button as well as the linear transition button, the quadratic function transition button or the circular arc transition button, the processing process according to the preset distorting-mirror algorithm refers to the condition when the user selects the left-to-right deformation button as well as the linear transition button, the quadratic function transition button or the circular arc transition button, and will not be described herein in detail.

It should be noted that: according to the embodiment of the present disclosure, the preset distorting-mirror algorithm may include but is not limited to the above four conditions.

According to an embodiment of the present disclosure, more than one or all of the above four distorting-mirror algorithms may be integrated into a camera APP of the electronic device, and the first designated image region, the second designated image region, the third designated image region and the fourth designated image region may be identical image regions or partly identical image regions. Therefore, when a photo is taken, the camera APP may provide a plurality of distorting-mirror effects for user's selection, and the distorting-mirror effects may be used in a superposed manner. For example, the image data in the first designated image region is compressed according to the first preset proportion, and/or the image data in the first designated image region is expanded according to the second preset proportion again, and/or the pixels in the first designated image region are equally divided into 100 portions along the preset direction and are separately given different coordinates in order, wherein each portion of pixels corresponds to a coordinate ranging from 1 to 100, the coordinates corresponding to each portion of pixels are transformed according to a preset transformation formula, and finally the each portion of pixels is shifted to the transformed coordinates, and/or the first designated image region is divided into the first image region and the second image region again; furthermore, the image data in the first image region is expanded according to the third preset proportion, and the image data in the second image region is compressed according to the fourth preset proportion, so that the user experience is greatly increased.

According to the method for realizing the photographing effect of the distorting mirror disclosed by the embodiment of the present disclosure, after the photographing mode of the electronic device is operated, each frame image data that is captured by the camera module of the electronic device in real time is acquired, and the each frame image data is processed in real time according to the preset distorting-mirror algorithm, and the processed image data is displayed in the photograph preview interface of the electronic device; after the photographing instruction is received, the image data that is collected by the camera module is acquired, and is processed according to the preset distorting-mirror algorithm, and a compressed and encoded picture is generated according to the processed image data. Therefore, the introduction of the distorting-mirror effect into photographing based on the camera function of the electronic device directly is realized, so that the photograph preview interface and a finished photo can directly present the distorting-mirror effect when the user takes a picture, so that it is intuitional and high-efficiency, and the user experience is good; in addition, as the image data that is collected by the camera module can be processed directly according to the preset distorting-mirror algorithm through a software system before the compression and encoding, the pixels of the picture can be prevented from loss to the maximum extent.

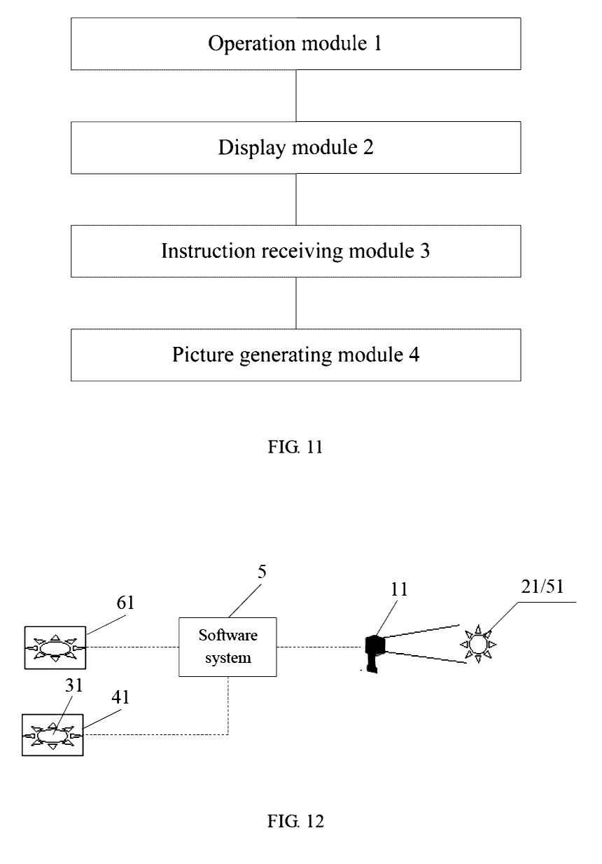

With reference to FIG. 11, which illustrates a structural block diagram of a device for realizing a photographing effect of a distorting mirror according to an embodiment of the present disclosure, the device for realizing the photographing effect of the distorting mirror may include:
an operation module 1, which is configured to operate a photographing mode of the electronic device;
wherein, when a user opens a camera function of the electronic device, the operation module 1 operates a photographing mode of the electronic device;
a display module 2, which is configured to acquire each frame image data that is captured by a camera module of the electronic device in real time, process each frame image data in real time according to a preset distorting-mirror algorithm, and display the processed image data on a photograph preview interface of the electronic device;
wherein the camera module may include a camera, an analog-to-digital conversion module and the like. Specifically, after the operation module 1, the camera module of the electronic device finds a view in real time; namely, the camera module receives optical information and performs earlier stage processing such as analog-to-digital conversion and the like on the received optical information to obtain the each frame image data.

According to the display module 2, when the camera module finds a view, each frame image data of a found view can be directly processed according to the preset distorting-mirror algorithm in advance and then transmitted to a display screen of the electronic device for display by means of a software system of the electronic device, so as to ensure no loss of pixels of a picture on a photograph preview interface, such as the photograph preview interface of a camera APP, to the maximum extent, and therefore a user can intuitively see the distorting-mirror effect of a photo in real time in the photograph preview interface, so that user experience is increased greatly.

An instruction receiving module 3, which is configured to receive a photographing instruction;

specifically, when the user confirms that the current distorting-mirror effect is a required distorting-mirror effect according to the photograph preview interface, the instruction receiving module 3 receives the photographing instruction if the user pushes a photographing button.

A picture generating module 4, which is configured to acquire the image data that is collected by the camera module, process the collected image data according to the preset distorting-mirror algorithm, and generate a compressed and encoded picture according to the processed image data.

After the instruction receiving module 3, the camera module collects optical information and performs earlier stage processing such as analog-to-digital conversion and the like on the collected optical information to obtain the collected image data.

Wherein, according to an embodiment of the present disclosure, the collected image data can be cached to a system memory after the camera module collects the image data, so that the picture generating module 4 can effectively process the collected image data according to the preset distorting-mirror algorithm.

Wherein, the picture generating module 4 can directly process the image data that is collected by the camera module and has not been compressed and encoded according to the preset distorting-mirror algorithm by means of the software system of the electronic device; furthermore, the processed image data is compressed and encoded to a picture in a preset format by means of the software system of the electronic device, and the picture has the distorting-mirror effect required by the user. Therefore, no loss of pixels of a finished picture can be ensured to the maximum extent, and the user experience is increased greatly. Specifically, the preset format may be a JPEG format, a GIF format, a PNG format and the like.

Wherein, after the collected image data is cached to the system memory and the picture generating module 4 generates the compressed and encoded picture according to the processed image data, the system memory that is occupied by the collected by the image data can also be released, so that system efficiency can be increased.

Specifically, according to an embodiment of the present disclosure, the preset distorting-mirror algorithm may include the step of compressing the image data in the first designated image region according to a first preset proportion.

Wherein, the step of compressing the image data in the first designated image region according to the first preset proportion may be the step of compressing the number of pixels of the image data in the first designated image region according to the first preset proportion, wherein the first preset proportion is greater than 0 and smaller than 1.

Specifically, after the user opens the camera function, a compression direction selection list may be displayed in the photograph preview interface, wherein the compression direction selection list may include a transverse compression button, a longitudinal compression button, a circular compression button and the like; a compression proportion regulation button or a compression proportion selection list and the like may be displayed in the photograph preview interface.

Wherein, when the user selects the transverse compression button, two longitudinal regulation lines are displayed in the photograph preview interface, the region between the two longitudinal regulation lines is the first designated image region, and the dimension of the first designated image region can be regulated when the user moves any of the longitudinal regulation lines; when the user selects the longitudinal compression button, two transverse regulation lines are displayed in the photograph preview interface, the region between the two transverse regulation lines is the first designated image region, and the dimension of the first designated image region can be regulated when the user moves any of the transverse regulation lines; when the user selects the circular compression button, a circular regulation line is displayed in the photograph preview interface, the region surrounded by the circular regulation line is the first designated image region, the dimension of the first designated image region can be regulated when the user regulates the radius of the circle. In addition, the user may regulate the first preset proportion by means of the compression proportion regulation button or the compression proportion selection list and the like.

Specifically, according to an embodiment of the present disclosure, the preset distorting-mirror algorithm may include the step of expanding the image data in a second designated image region according to a second preset proportion, wherein the second preset proportion is larger than 1.

Wherein, the step of expanding the image data in the second designated image region according to the second preset proportion may be the step of expanding the number of pixels of the image data in the second designated image region according to the second preset proportion.

Specifically, after the user opens the camera function, an expansion direction selection list may be displayed in the photograph preview interface, wherein the expansion direction selection list may include a transverse expansion button, a longitudinal expansion button, a circular expansion button and the like; an expansion proportion regulation button or an expansion proportion selection list and the like may be displayed in the photograph preview interface.

Wherein, when the user selects the transverse expansion button, two longitudinal regulation lines are displayed in the photograph preview interface, the region between the two longitudinal regulation lines is the second designated image region, and the dimension of the second designated image region can be regulated when the user moves any of the longitudinal regulation lines; when the user selects the longitudinal expansion button, two transverse regulation lines are displayed in the photograph preview interface, the region between the two transverse regulation lines is the second designated image region, and the dimension of the second designated image region can be regulated when the user moves any of the transverse regulation lines; when the user selects the circular expansion button, a circular regulation line is displayed in the photograph preview interface, the region surrounded by the circular regulation line is the second designated image region, the dimension of the second designated image region can be regulated when the user regulates the radius of the circle. In addition, the user may regulate the second preset proportion by means of the expansion proportion regulation button or the expansion proportion selection list and the like.

According to a further embodiment of the present disclosure, the preset distorting-mirror algorithm may include the steps of equally dividing pixels in a third designated image region into 100 portions along a preset direction and giving different coordinates in order, wherein each portion of pixels corresponds to a coordinate ranging from 1 to 100, the coordinates corresponding to each portion of pixels are transformed according to a preset transformation formula, and finally the each portion of pixels is shifted to the transformed coordinates, wherein the preset direction may be a transverse direction, a longitudinal direction or a circumferential direction and the like.

Specifically, the preset transformation formula specifically may be:

y=10*\sqrt{x}, or

y=(x/10)²

wherein x is a coordinate corresponding to any of the 100 portions of pixels, and y is a transformed coordinate.

It should be noted that: as for the preset transformation formula y=10*\sqrt{x} or y=(x/10)², when the value of x ranges from 0 to 100, the value of y also ranges from 0 to 100, wherein the value of x may be an integer or a non-integer within 0-100. Therefore, an image in the third designated image region may be deformed according to the preset distorting-mirror algorithm, pixels of the image in the third designated image region do not overflow or decrease, so that images outside the third designated image region will not be affected.

According to another embodiment of the present disclosure, the preset distorting-mirror algorithm may include the following steps: dividing a fourth designated image region into a first image region and a second image region, expanding the image data in the first image region according to a third preset proportion, and compressing the image data in the second image region according to a fourth preset proportion, wherein the third preset proportion is larger than 0 and smaller than 1, and the fourth preset proportion is larger than 1.

Specifically, after the user opens the camera function, a deformation direction selection list may be displayed in the photograph preview interface, wherein the deformation direction selection list may include a left-to-right deformation button, a right-to-left deformation button, a top-to-bottom deformation button, a bottom-to-top deformation button and the like; a rectangular regulation line, a square regulation line, a circular regulation line or the like may be displayed in the photograph preview interface. The region surrounded by the rectangular regulation line, the square regulation line or the circular regulation line is the fourth designated image region, a compression proportion regulation button or a compression proportion selection list and the like may be displayed in the photograph preview interface, or an expansion proportion regulation button or an expansion proportion selection list and the like may be displayed in the photograph preview interface.

Wherein, when the user selects the left-to-right deformation button or the right-to-left deformation button, the fourth designated image region may be divided into a first image region at the left part and a second image region at the right part by a longitudinal dividing line according to the preset distorting-mirror algorithm, the longitudinal dividing line and an outer frame at the upper part of the fourth designated image region has a first intersection, the longitudinal dividing line and an outer frame at the lower part of the fourth designated image region has a second intersection: when the user selects the top-to-bottom deformation button or the bottom-to-top deformation button, the fourth designated image region may be divided into a first image region at the upper part and a second image region at the lower part by a transverse dividing line according to the preset distorting-mirror algorithm, the transverse dividing line and an outer frame at the left part of the fourth designated image region has a third intersection, and the transverse diving line and an outer frame at the right part of the fourth designated image region has a fourth intersection.

Specifically, the dimension of the fourth designated image region may be regulated when the user regulates the rectangular regulation line, the square regulation line or the circular regulation line; the third preset proportion may be regulated by setting a compression proportion regulation button or a compression proportion selection list and the like; the fourth preset proportion may be regulated by setting an expansion proportion regulation button or an expansion proportion selection list.

Wherein, the steps of expanding the image data in the first image region according to the third preset proportion and compressing the image data in the second image region according to the fourth preset proportion include the following steps:

expanding the image data in the first image region in a gradually increased manner according to a preset transition mode, and compressing the image data in the second image region in a gradually increased manner according to a preset transition mode.

It should be noted that: to expand the image data in the first image region in the gradually increased manner according to the preset transition mode and to compress the image data in the second image region in the gradually increased manner according to the preset transition mode can ensure a smooth and gradual transition of images at the edge of the fourth designated image region and images outside the fourth designated image region.

Specifically, after the user opens the camera function, a transition mode selection list may be displayed in the photograph preview interface, wherein the transition mode selection list may include a linear transition button, a quadratic function transition button or a circular arc transition button and the like, wherein a first transition straight line and a second transition straight line are displayed in the photograph preview interface when the user selects the linear transition button, a first transition arc line and a second transition arc line are displayed in the photograph preview interface when the user selects the quadratic function transition button, and a transition circular are is displayed in the photograph preview interface when the user selects the circular arc transition button.

According to an embodiment of the present disclosure, the electronic device is a mobile phone. With reference to FIG. 12, when the user opens the camera function of the mobile phone, a camera module 11 of the mobile phone captures image data 21, a display module 2 processes the image data 21 according to the preset distorting-mirror algorithm by means of a software system 5, and a display module 3 displays the processed image data 31 on a photograph preview interface 41 of a camera APP in real time. After the user confirms that the current distorting-mirror effect is a required distorting-mirror effect and pushes a photographing button, an instruction receiving module 3 receives a photographing instruction, a picture generating module 4 acquires image data 51 that is collected by the camera module 11, without being compressed, encoded and uploaded in a JPEG format, the picture generating module 4 processes the image data 51 according to the preset distorting-mirror algorithm by means of the software system 5, so as to generate a compressed and encoded picture 61 according to the image data 51, the compressed and encoded picture 61 is a picture in the JPEG format, the camera APP is notified to save the picture to finish photographing.

It should be noted that: according to the embodiment of the present disclosure, the preset distorting-mirror algorithm may include but is not limited to the above four conditions.

According to an embodiment of the present disclosure, more than one or all of the above four distorting-mirror algorithms may be integrated into a camera APP of the electronic device, and the first designated image region, the second designated image region, the third designated image region and the fourth designated image region may be identical image regions or partly identical image regions. Therefore, when a photo is taken, the camera APP may provide a plurality of distorting-mirror effects for user's selection, and the distorting-mirror effects may be used in a superposed manner. For example, the image data in the first designated image region is compressed according to the first preset proportion, and/or the image data in the first designated image region is expanded according to the second preset proportion again, and/or the pixels in the first designated image region are equally divided into 100 portions along the preset direction and are separately given different coordinates in order, wherein each portion of pixels corresponds to a coordinate ranging from 1 to 100, the coordinates corresponding to each portion of pixels are transformed according to a preset transformation formula, and finally the each portion of pixels is shifted to the transformed coordinates, and/or the first designated image region is divided into the first image region and the second image region again; furthermore, the image data in the first image region is expanded according to the third preset proportion, and the image data in the second image region is compressed according to the fourth preset proportion, so that the user experience is greatly increased.

According to the device for realizing the photographing effect of the distorting mirror disclosed by the embodiment of the present disclosure, after the operation module operates a photographing mode of the electronic device, each frame image data that is captured by the camera module of the electronic device in real time is acquired, and is processed in real time according to the preset distorting-mirror algorithm, and the processed image data is displayed in the photograph preview interface of the electronic device. After the instruction receiving module receives the photographing instruction, the picture generating module acquires the image data that is collected by the camera module, processes the collected image data according to the preset distorting-mirror algorithm, and generates a compressed and encoded picture according to the processed image data. Therefore, the introduction of the distorting-mirror effect into photographing based on the camera function of the electronic device directly is realized, so that the photograph preview interface and a finished photo can directly present the distorting-mirror effect when the user takes a picture, so that it is intuitional and high-efficiency, and the user experience is good; in addition, as the image data that is collected by the camera module can be processed directly according to the preset distorting-mirror algorithm before the compression and encoding, the pixels of the picture can be prevented from loss to the maximum extent.

Device embodiments are briefly described herein as they are substantially similar to method embodiments; please refer to the description of the method embodiments for associated parts.

The embodiment of the present disclosure further provides a non-transitory computer readable medium storing executable instructions that, when executed by an electronic device, cause the electronic device to execute the method for realizing a photographing effect of a distorting mirror above.

The embodiment of the present disclosure further provides a computer program, including executable instructions, wherein the executable instructions operate on an electronic device such that the electronic device executes the method for realizing a photographing effect of a distorting mirror above.

The device embodiments described above are schematic only, wherein units described as separate components can be or cannot be separated physically; components which are adopted as display units display can be or cannot be physical units, namely located on a place or distributed to a plurality of network units. The purpose of the schemes in the embodiment can be achieved via partial or all modules according to actual requirements. A person skilled in the art can understand and implement without creative labor.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

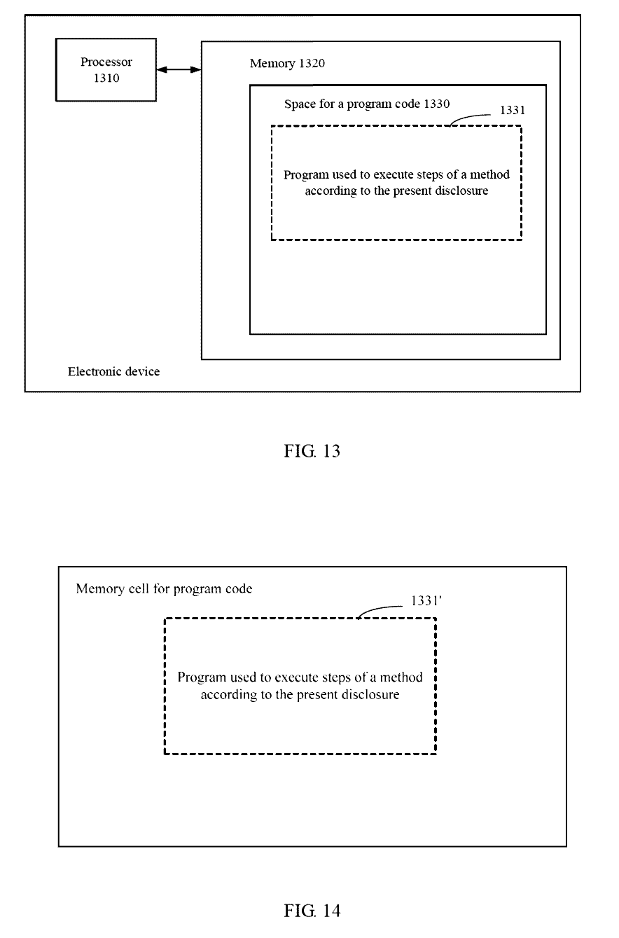

For example, FIG. 13 illustrates a block diagram of an electronic device for executing the method according the disclosure. Traditionally, the electronic device includes a processor 1310 and a computer program product or a computer readable medium in form of a memory 1320. The memory 1320 could be electronic memories such as flash memory, EEPROM (Electrically Erasable Programmable Read—Only Memory), EPROM, hard disk or ROM. The memory 1320 has a memory space 1330 for executing program codes 1331 of any steps in the above methods. For example, the memory space 1330 for program codes may include respective program codes 1331 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 14. The memory cells may be provided with memory sections, memory spaces, etc., similar to the memory 1320 of the electronic device as shown in FIG. 13. The program codes may be compressed for example in an appropriate form. Usually, the memory cell includes computer readable codes 1331′ which can be read for example by processors 1310. When these codes are operated on the electronic device, the electronic device may execute respective steps in the method as described above.

Through the description of the above embodiments, a person skilled in the art can clearly know that the embodiments can be implemented by software and necessary universal hardware platforms, or by hardware. Based on this understanding, the above solutions or contributions thereof to the prior art can be reflected in form of software products, and the computer software products can be stored in computer readable media, for example, ROM/RAM, magnetic discs, optical discs, etc., including various commands, which are used for driving a computer device (which may be a personal computer, a server or a network device) to execute methods described in all embodiments or in some parts of the embodiments.

Finally, it should be noted that the above embodiments are merely used to describe instead of limiting the technical solution of the present disclosure; although the above embodiments describe the present disclosure in detail, a person skilled in the art shall understand that they can modify the technical solutions in the above embodiments or make equivalent replacement of some technical characteristics of the present disclosure; those modifications or replacement and the corresponding technical solutions do not depart from the spirit and scope of the technical solutions of the above embodiments of the present disclosure.

What is claimed is:

1. A method for realizing a photographing effect of a distorting mirror, comprising:
operating a photographing mode of an electronic device;
acquiring image data of each frame which is captured in real time by a camera module of the electronic device; processing the image data of each frame in real time according to a preset distorting-mirror algorithm, and displaying the processed image data on a photograph preview interface of the electronic device;
receiving a photographing instruction; and
acquiring the image data collected by the camera module, processing the collected image data according to the preset distorting-mirror algorithm, and generating a compressed and encoded picture according to the processed image data.

2. The method according to claim 1, wherein the preset distorting-mirror algorithm comprises:
compressing the image data in a first designated image region according to a first preset proportion; or
expanding the image data in a second designated image region according to a second preset proportion.

3. The method according to claim 1, wherein the preset distorting-mirror algorithm comprises:
equally dividing pixels in a third designated image region into 100 portions along a preset direction;
giving the 100 portions of pixels different coordinates respectively in order, wherein each portion of pixels corresponds to a coordinate ranging from 1 to 100:
transforming coordinates corresponding to each portion of pixels according to a preset transformation formula; and
shifting the each portion of pixels to transformed coordinates.

4. The method according to claim 3, wherein the preset transformation formula is specifically:
y=10*\sqrt{x}, or
y=(x/10)²
wherein x is a coordinate corresponding to any of the 100 portions of pixels, and y is a transformed coordinate.

5. The method according to claim 1, wherein the preset distorting-mirror algorithm comprises:
dividing a fourth designated image region into a first image region and a second image region; and
expanding the image data in the first image region according to a third preset proportion, and compressing the image data in the second image region according to a fourth preset proportion.

6. The method according to claim 5, wherein expanding the image data in the first image region according to the third preset proportion and compressing the image data in the second image region according to the fourth preset proportion comprise:
expanding the image data in the first image region in a gradually increased manner according to a preset transition mode, and compressing the image data in the second image region in a gradually increased manner according to the preset transition mode.

7. An electronic device, comprising:
at least one processor, and
a memory communicably connected with the at least one processor for storing instructions executable by the at least one processor, wherein execution of the instructions by the at least one processor causes the at least one processor to:
operate a photographing mode of the electronic device;
acquire image data of each frame which is captured in real time by a camera module of the electronic device, process the image data of each frame in real time according to a preset distorting-mirror algorithm, and display the processed image data on a photograph preview interface of the electronic device;
receive a photographing instruction; and
acquire the image data collected by the camera module, process the collected image data according to the preset distorting-mirror algorithm, and generate a compressed and encoded picture according to the processed image data.

8. The electronic device according to claim 7, wherein the preset distorting-mirror algorithm comprises:
compressing the image data in a first designated image region according to a first preset proportion: or
expanding the image data in a second designated image region according to a second preset proportion.

9. The electronic device according to claim 7, wherein the preset distorting-mirror algorithm comprises:
equally dividing pixels in a third designated image region into 100 portions along a preset direction;
giving the 100 portions of pixels different coordinates respectively in order, wherein each portion of pixels corresponds to a coordinate ranging from 1 to 100;
transforming the coordinates corresponding to each portion of pixels according to a preset transformation formula; and
shifting the each portion of pixels to transformed coordinates.

10. The electronic device according to claim 9, wherein the preset transformation formula is specifically:
y=10*\sqrt{x}, or
y=(x/10)²
wherein x is a coordinate corresponding to any of the 100 portions of pixels, and y is a transformed coordinate.

11. The electronic device according to claim 7, wherein the preset distorting-mirror algorithm comprises:
dividing a fourth designated image region into a first image region and a second image region; and
expanding the image data in the first image region according to a third preset proportion, and compressing the image data in the second image region according to a fourth preset proportion.

12. The electronic device according to claim 11, wherein expand the image data in the first image region according to the third preset proportion and compress the image data in the second image region according to the fourth preset proportion comprise:
expanding the image data in the first image region in a gradually increased manner according to a preset transition mode, and compressing the image data in the second image region in a gradually increased manner according to a preset transition mode.

13. A non-transitory computer readable medium storing executable instructions that, when executed by an electronic device, cause the electronic device to:
operate a photographing mode of the electronic device;
acquire image data of each frame which is captured in real time by a camera module of the electronic device, process the each frame image data in real time according to a preset distorting-mirror algorithm, and display the processed image data on a photograph preview interface of the electronic device:
receive a photographing instruction; and
acquire the image data that is collected by the camera module, process the collected image data according to the preset distorting-mirror algorithm, and generate a compressed and encoded picture according to the processed image data.

14. The non-transitory computer readable medium according to claim 13, wherein the preset distorting-mirror algorithm comprises:
compressing the image data in a first designated image region according to a first preset proportion; or
expanding the image data in a second designated image region according to a second preset proportion.

15. The non-transitory computer readable medium according to claim 13, wherein the preset distorting-mirror algorithm comprises:
equally dividing pixels in a third designated image region into 100 portions along a preset direction:
giving the 100 portions of pixels different coordinates respectively in order, wherein each portion of pixels corresponds to a coordinate ranging from 1 to 100;
transforming the coordinates corresponding to each portion of pixels according to a preset transformation formula; and
shifting the each portion of pixels to transformed coordinates.

16. The non-transitory computer readable medium according to claim 15, wherein the preset transformation formula is:
y=10*\sqrt{x}, or
y=(x/10)²
wherein x is a coordinate corresponding to any of the 100 portions of pixels, and y is a transformed coordinate.

17. The non-transitory computer readable medium according to claim 13, wherein the preset distorting-mirror algorithm comprises:
dividing a fourth designated image region into a first image region and a second image region; and
expanding the image data in the first image region according to a third preset proportion, and compressing the image data in the second image region according to a fourth preset proportion.

18. The non-transitory computer readable medium according to claim 17, wherein expand the image data in the first image region according to the third preset proportion and compress the image data in the second image region according to the fourth preset proportion comprise:
expanding the image data in the first image region in a gradually increased manner according to a preset transition mode, and compressing the image data in the second image region in a gradually increased manner according to a preset transition mode.
